(19) United States
(12) Patent Application Publication
(10) Pub. No.: US 2026/0135331 A1
(43) Pub. Date: May 14, 2026

(54) CONNECTOR UNIT

(71) Applicant: Yazaki Corporation, Tokyo (JP)

(72) Inventors: Shiori TSUCHIYA, Makinohara-shi (JP); Hiroshi MIYAZAKI, Tokyo (JP)

(73) Assignee: Yazaki Corporation, Tokyo (JP)

(21) Appl. No.: 19/381,367

(22) Filed: Nov. 6, 2025

(30) Foreign Application Priority Data
Nov. 12, 2024 (JP) 2024-197435

(51) Int. Cl. H01R 13/629

(52) U.S. Cl. CPC H01R 13/62933

(57) ABSTRACT

A connector unit includes: a partner connector; a connector main body; and a lever pivotably mounted to the connector main body, wherein the lever is rotatable between an initial position and a completely rotated position, wherein the lever includes: a pair of arm plates; and a connecting portion connecting the pair of arm plates to each other, wherein a lock section is provided on one of the pair of arm plates, the lock section being configured to lock the partner connector in the completely rotated position, wherein the connecting portion includes an contact surface which is configured to come into contact with the partner connector in the completely rotated position, and wherein the contact surface is oblique so that a root of another of the pair of arm plates is positioned farther away from the partner connector than a root of the one of the pair of arm plates.

### BACKGROUND OF THE INVENTION

### Technical Field

The present invention relates to a connector unit.

### Background Art

A lever-operated connector is known which includes a connector main body and a lever, the connector main body holding terminals and the lever being rotatably supported by the connector main body, wherein as the lever is rotated, a partner connector is moved toward the connector main body to be mated therewith (see e.g. Patent Document 1).

FIG. 7 shows a conventional lever-operated connector 101. The lever-operated connector 101 includes a connector main body 102, a lever 103, and a lock portion 103A, the connector main body 102 being configured to be mated with a partner connector (now shown), wherein the lock portion 103A is provided at the lever 103 and configured to be locked to the partner connector when the partner connector is mated with the connector main body 102.

The lever 103 includes a pair of opposed arm sections 103B (only one of the pair of arm sections is shown), and an operating section 103C connecting the pair of arm sections 103B, wherein the lever 103 is thus configured in the form of a gate. When the lever 103 is rotated and the partner connector is thus mated with the connector main body 102, the partner connector is locked by a lock portion 103A so that a mated state of the partner connector with the connector main body 102 is maintained, wherein the lock portion 103A is provided at one of the pair of arm sections 103B.

### CITATION LIST

### Patent Literature

Patent Document 1: JP 2023-109418 A

### SUMMARY OF THE INVENTION

However, in the case of a gate-shaped lever 103, an operator, when operating the lever 103 by rotation, may not grip the lever 103 at a location thereof which allows a force to act evenly on the pair of arm sections 103B, but may grip the lever 103 at an unbalanced location thereof to operate the lever 103. In such a case, an operation force exerted by the operator may not be transferred to the pair of arm sections 103B, wherein the lever 103 may be deformed to be twisted. The operating section 103C may then interfere with the partner connector before the partner connector is locked by the lock portion 103A provided at the one 103B of the pair of arm sections 103B, which may prevent the operating section 103C from being further pressed so that the partner connector may not be locked by the lock portion 103A. In this manner, the mated state of the partner connector with the connector main body 102 may not be maintained, i.e., a failure in mating the partner connector may occur.

An objective of the present invention is to provide a connector unit which may improve operation efficiency of a mating operation of a connector while enabling failures in mating the partner connector to be suppressed.

In order to achieve the above-mentioned objective, the invention according to claim 1 relates to a connector unit including: a partner connector and a connector main body which are capable of being mated with each other; and a lever pivotably mounted to the connector main body and configured to be rotated relative to the connector main body, wherein the lever is capable of being rotated between an initial position and a completely rotated position, wherein in the completely rotated position, the partner connector is moved toward the connector main body and mated therewith, wherein the lever includes: a pair of arm plates which are opposed to each other with the connector main body being interposed between the pair of arm plates; and a connecting portion connecting the pair of arm plates to each other, wherein a lock section is provided on one of the pair of arm plates, the lock section being configured to lock the partner connector in the completely rotated position, wherein the connecting portion includes an opposed surface which is configured to be opposed to the partner connector and capable of coming into contact with the partner connector in the completely rotated position, and wherein the opposed surface is oblique so that a root of another of the pair of arm plates is positioned farther away from the partner connector than a root of the one of the pair of arm plates.

The invention according to claim 1 may improve operation efficiency of a mating operation of a connector while enabling failures in mating the partner connector to be suppressed.

### BRIEF DESCRIPTION OF THE DRAWINGS

FIG. 1 shows an exploded perspective view of a lever-operated connector forming part of a connector unit according to an embodiment of the present invention;

FIG. 2 shows a perspective view illustrating a state in which the lever-operated connector is in an initial position;

FIG. 3 shows a perspective view of the lever-operated connector in a completely rotated position;

FIG. 4 shows a side view illustrating how the lever is rotated to mate a connector main body of the lever-operated connector with a partner connector;

FIG. 5 shows a side view illustrating a state in which after further rotation of the lever, the lever is positioned in the completely rotated position and the connector main body is thus mated with the partner connector;

FIG. 6A shows a longitudinal sectional view of the lever-operated connector and the partner connector as shown in FIG. 5;

FIG. 6B shows an enlarged view of an essential part of FIG. 6A; and

FIG. 7 shows a conventional lever-operated connector.

### DETAILED DESCRIPTION OF THE PREFERRED EMBODIMENTS

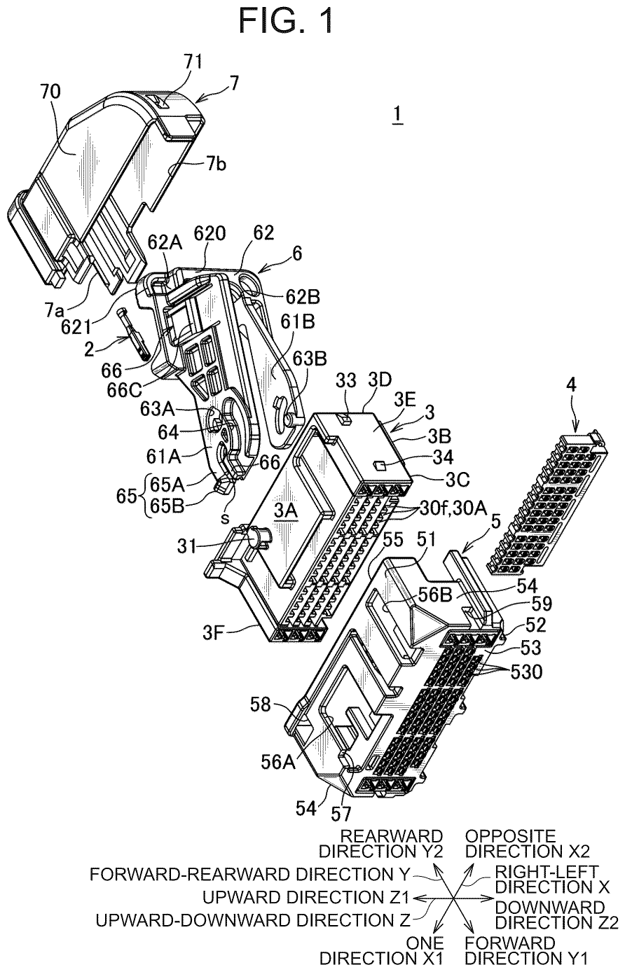

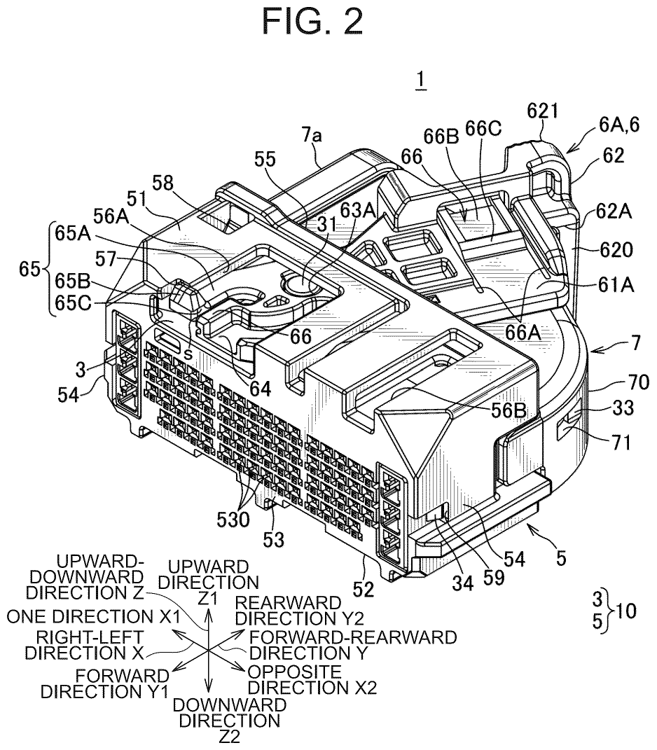

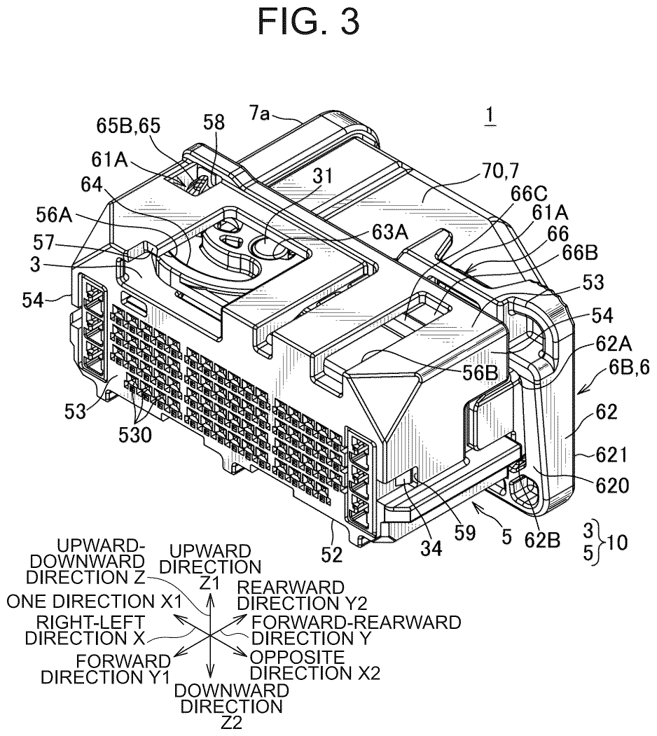

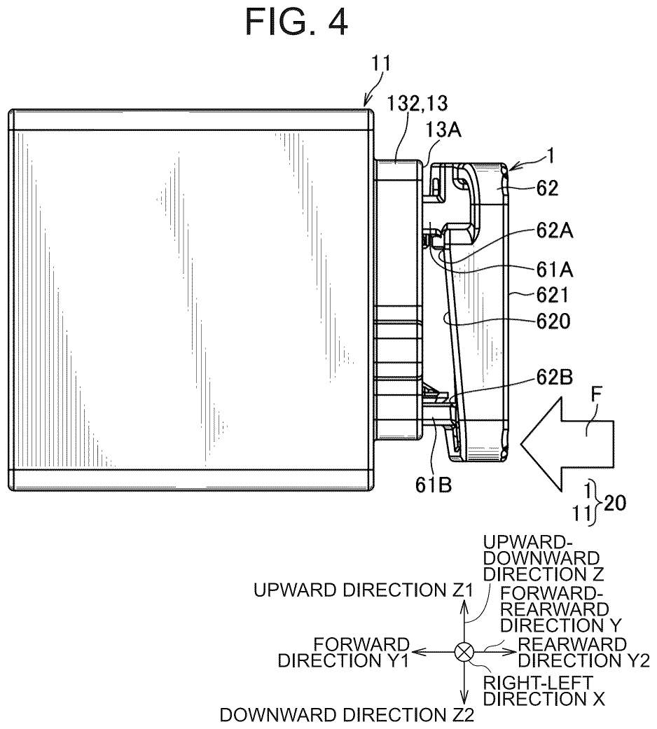

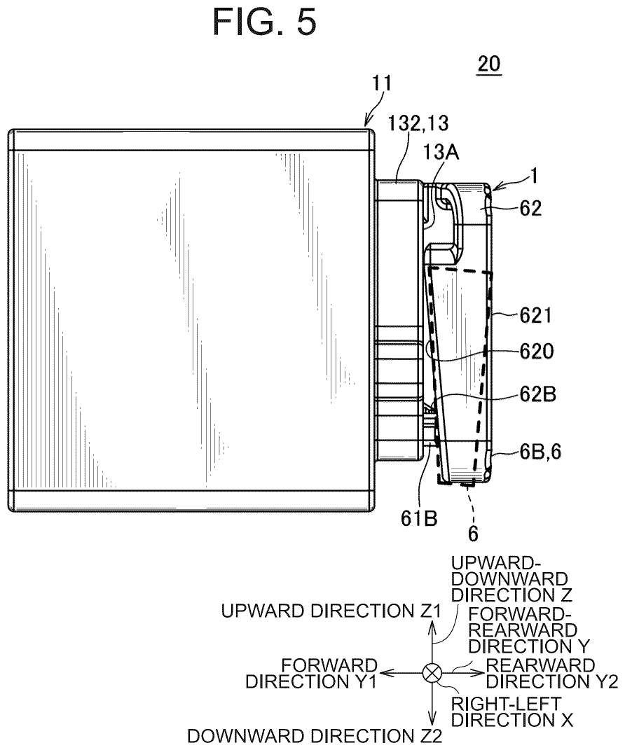

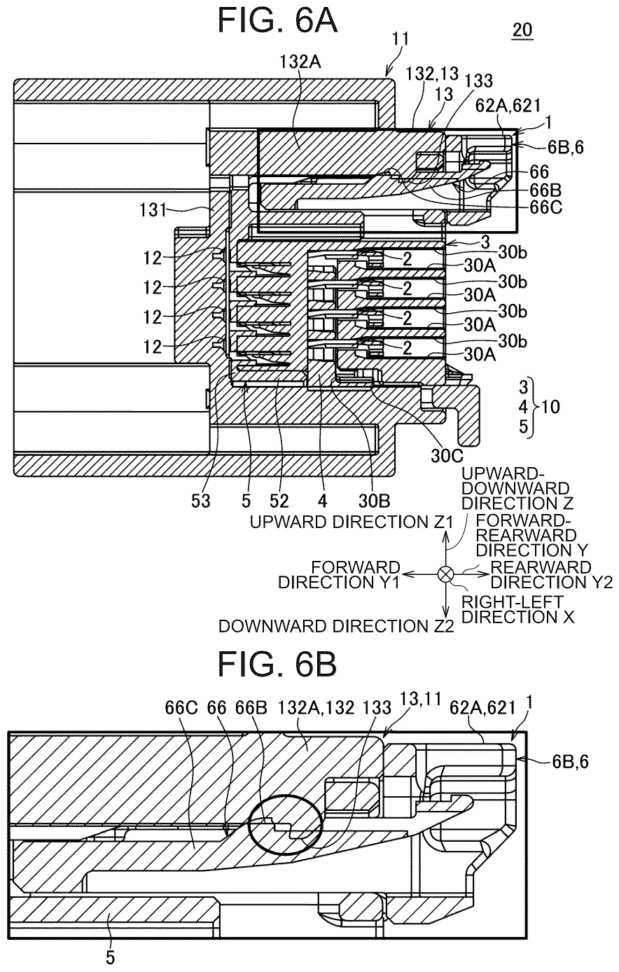

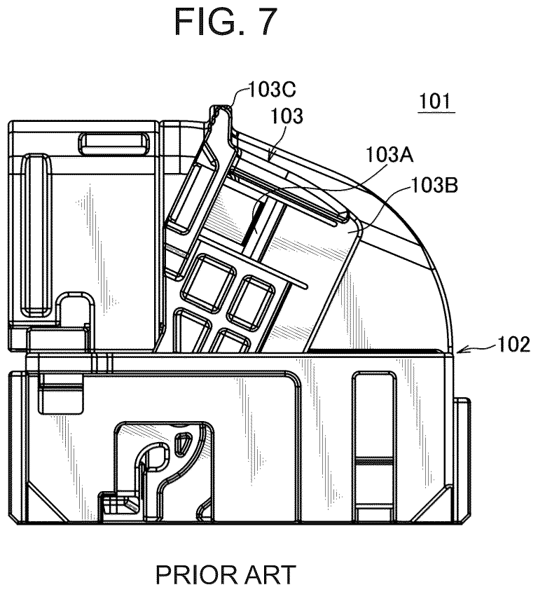

Hereinafter, a “connector unit 20” according to an embodiment of the present invention will be described with reference to FIGS. 1 to 6. FIG. 1 shows an exploded perspective view of a lever-operated connector 1 forming part of a connector unit 20 according to an embodiment of the present invention. FIG. 2 shows a perspective view illustrating a state in which the lever-operated connector 1 is in an initial position 6A. FIG. 3 shows a perspective view of the lever-operated connector 1 in a completely rotated position 6B. FIG. 4 shows a side view illustrating how the lever 6 is rotated to mate a connector main body 10 of the lever-operated connector 1 with a partner connector 11. FIG. 5 shows a side view illustrating a state in which after further rotation of the lever 6, the lever 6 is positioned in the completely rotated position 6B and the connector main body 10 is thus mated with the partner connector 11. FIG. 6A shows a longitudinal sectional view of the connector main body 10 and the partner connector 11 as shown in FIG. 5. FIG. 6B shows an enlarged view of an essential part of FIG. 6A. It is to be noted that a cover 7 forming part of the lever-operated connector 1 is omitted in FIGS. 4 to 6.

The connector unit 20 includes a partner connector 11 and a connector main body 10 which are capable of being mated with each other. The connector unit 20 further includes a lever 6 pivotably mounted to the connector main body 10 and configured to be rotated relative to the connector main body 10. The connector unit 20 is configured in such a manner that when the lever 6 is in an initial position 6A (shown in FIG. 2), the partner connector 11 is moved toward the connector main body 10, wherein the partner connector 11 and the connector main body 10 are configured to be mated with each other by positioning the lever 6 in a completely rotated position 6B (shown in FIG. 3). The connector main body 10 and the lever 6 form the lever-operated connector 1.

In the context of the present embodiment, arrow X, arrow Y and arrow Z shall extend orthogonally to each other. A direction of mating the lever-operated connector 1 with the partner connector 11 shall be defined as the direction Y (referred to as “forward-rearward direction Y”). A direction of an axis of rotation of the lever 6 shall be defined as the direction Z (referred to as “upward-downward direction Z”). A direction orthogonal to the direction Y and the direction Z shall be defined as the direction X (referred to as “right-left direction X”). A direction Y1 along the forward-rearward direction Y (pointing toward the partner connector 11 for the lever-operated connector 1) may be indicated with “forward direction”, and an opposite direction Y2 along the forward-rearward direction Y may be indicated with “rearward direction”. A direction Z1 along the upward-downward direction Z (pointing toward a first arm plate 61A) may be indicated with “upward direction”, and an opposite direction Z2 along the upward-downward direction Z (pointing toward a second arm plate 61B) may be indicated with “downward direction”.

As shown in FIGS. 4 to 6, the partner connector 11 includes partner terminals 12 (shown in FIG. 6A) and a partner housing 13 accommodating the partner terminals 12.

As shown in FIG. 6, the partner housing 13 is formed e.g. by a resin element and in a quadrilateral-tubular shape which has a direction of extension (direction of an axis of the tube) along the Y-direction. The partner housing 13 includes a partner wall section 131 extending along a XZ-plane, and a hood section 132 as shown in FIG. 6, wherein the hood section 132 is continuous with the partner wall section 131 and provided for mating the lever-operated connector 1.

As shown in FIGS. 4 and 5, a connector façade 13A is provided at the hood section 132, wherein the connector façade 13A is configured for inserting the lever-operated connector 1 therein which will be described below. The connector façade 13A is defined by an end face extending along the XZ-plane and is configured to come into contact with a contact surface 620 of the lever 6—which will be described below-when the lever-operated connector 1 reaches a completely rotated position 6B.

As shown in FIG. 6, a guide protrusion (not shown) and an engagement protrusion 133 are provided on a partner upper wall 132A of the hood section 132, wherein the partner upper wall 132A extends along a XY-plane. The guide protrusion is formed to protrude from the partner upper wall 132A in the downward direction Z2. The guide protrusion is configured to be inserted into and guided by a cam groove 64 of the lever 6 of the lever-operated connector 1 which will be described below.

The engagement protrusion 133 is formed to protrude in the downward direction Z2. The engagement protrusion 133 is configured to be engaged with a lock protrusion 66C of the lever-operated connector 1 when the lever-operated connector 1 reaches the completely rotated position 6B and is mated with the partner connector 11.

The lever-operated connector 1 as shown in FIGS. 1 to 3 includes a connector main body 10, the lever 6, and a cover 7. For example, the connector main body 10 includes a plurality of female terminals 2 (shown in FIG. 1), an inner housing 3 (housing) accommodating the plurality of female terminals 2, and a front mask 5 (holder) accommodating the inner housing 3. The lever 6 is pivotably mounted to the inner housing 3 and configured to be rotated between an initial position 6A (shown in FIG. 2) and the completely rotated position 6B (shown in FIG. 3), wherein the lever-operated connector 1 is mated with the partner connector 11 in the completely rotated position 6B. The cover 7 is configured to arrange electric wires therethrough which are connected to the plurality of female terminals 2.

As shown in FIG. 1, the connector main body 10 includes the inner housing 3 accommodating the plurality of female terminals 2, a spacer 4, and the front mask 5. The spacer 4 is configured to be supported by the inner housing 3 and locked to the female terminals 2. The front mask 5 includes a temporary lock receiving portion 57 and a final lock receiving portion 58 which are configured to be locked to a lock arm 65 of the lever 6 which will be described below.

As shown in FIG. 1, the female terminals 2 connected to terminals of the electric wires (not shown) are accommodated in terminal accommodating chambers 30A of the inner housing 3, which will be described below. The electric wires connected to the female terminals 2 are drawn out of the respective terminal accommodating chambers 30A in the rearward direction Y2, wherein the electric wires are then inserted through an electric wire insertion opening 7a in the cover 7—which will be described below—and drawn out in one direction along the right-left direction X.

The inner housing 3 is made of an insulating resin. As shown in FIGS. 1 and 6A, the inner housing 3 includes an upper surface 3A, a lower surface 3B, a front surface 3C, a rear surface 3D, right and left lateral surfaces 3E and 3F, the plurality of terminal accommodating chambers 30A, and a spacer accommodating chamber 30B (shown in FIG. 30A), wherein the upper surface 3A and lower surface 3B extend along a XY-plane, and the front surface 3C, rear surface 3D and lateral surfaces 3E and 3F are continuous with the upper surface 3A and the lower surface 3B. A rotation shaft 31 is provided on each of the upper surface 3A and lower surface 3B to pivotably mount the lever 6 thereto. A spacer opening 30C (shown in FIG. 6A) is formed in the lower surface 3B to insert the spacer 4 therein, which will be described below. A cover lock receiving portion 33 and a mask lock receiving portion 34 are provided on each of the right and left lateral surfaces 3E and 3F, wherein the cover lock receiving portion 33 is configured to be locked to a housing lock portion 71 of the cover 7 as described below, and the mask lock receiving portion 34 is configured to be locked to a housing lock portion 59 of the front mask 5 as described below.

The plurality of terminal accommodating chambers 30A is arranged along the upward-downward direction Z and along the right-left direction X. Each of the terminal accommodating chambers 30A is formed in a quadrilateral-tubular shape and configured to accommodate a corresponding one of the female terminals 2. The quadrilateral-tubular shape has a direction of extension (direction of an axis of the tube) along the Y-direction.

As shown in FIG. 6A, each of the terminal accommodating chambers 30A is opened in both of the forward direction Y1 and rearward direction Y2. One of the openings of each of the terminal accommodating chambers 30A which is oriented in the forward direction Y1 (which may be hereinafter referred to as “front opening 30f”) is provided for inserting one of partner terminals 12 of the partner connector 11 into the terminal accommodating chamber 30A. An electric wire connected to each of the female terminals 2 is drawn out of the corresponding one of the terminal accommodating chambers 30A through one of the openings of each of the terminal accommodating chambers 30A which is oriented in the rearward direction Y2 (which may be hereinafter referred to as “rear opening 30b”). Furthermore, a terminal lance (not shown) is provided on an inner surface of each of the terminal accommodating chambers 30A and configured to be locked to a corresponding one of the female terminals 2. The terminal lances and the spacer 4 (which will be described below) provide a double-lock effect of the female terminals 2 to limit removal of the female terminals 2 out of the respective terminal accommodating chambers 30A.

As shown in FIG. 6A, the spacer accommodating chamber 30B is formed by part of the terminal accommodating chambers 30A and configured to accommodate the spacer 4 as described below.

Each of the rotation shafts 31 is provided on one of the upper surface 3A and the lower surface 3B and is configured to be inserted through a corresponding one of bearings 63A and 63B of the lever 6 to pivotably mount the lever 6.

The spacer 4 is configured to be inserted into the spacer opening 30C formed in the lower surface 3B of the inner housing 3 to be accommodated into the spacer accommodating chamber 30B, as shown in FIG. 6A. The spacer 4 is configured to be displaceable between the temporary locked position and the final locked position. While the spacer 4 is in the temporary locked position, the female terminals 2 are inserted into the respective terminal accommodating chambers 30A to engage the female terminals 2 with the respective lances so that primary lock of the female terminals 2 is provided. This spacer 4 is displaced from the temporary locked position to the final locked position to engage the female terminals 2 with the spacer 4 so that secondary lock of the female terminals 2 is provided.

The front mask 5 is made of an insulating resin. As shown in FIG. 1, the front mask 5 includes an upper wall 51, a lower wall 52, a front wall 53, right and left lateral walls 54, 54, a first exposure opening 56A, a temporary lock receiving portion 57, a final lock receiving portion 58, and a second exposure opening 56B, wherein the upper wall 51 and lower wall 52 extend along a XY-plane, and the front wall 53 and lateral walls 54, 54 are continuous with the upper wall 51 and the lower wall 52. The first exposure opening 56A is formed in a box shape which includes an accommodation opening 55 for receiving the inner housing 3, wherein the first exposure opening 56A is configured to expose a forward end side of the lever 6 as described below. The temporary lock receiving portion 57 is defined at a peripheral edge of the first exposure opening 56A and configured to be locked to the lock arm 65 on the lever 6 in the initial locked position 6A. The final lock receiving portion 58 is configured to be locked to the lock arm 65 in the completely rotated position 6B. The second exposure opening 56B is configured to expose a lock structure 66 provided on the lever 6.

The front wall 53 has communication holes 530, wherein each of the communication holes 530 is formed in a position of the front wall 53 in which the communication hole 530 is in communication with a front opening 30f of a corresponding one of the terminal accommodating chambers 30A in the inner housing 3. A housing lock portion 59 is provided on each of the right and left lateral walls 54, 54 and configured to be locked to a corresponding one of the mask lock receiving portions 34 of the inner housing 3.

The first exposure opening 56A is formed by cutting out part of the upper wall 51 and front wall 53 to expose the lock arm 65 and an entrance opening of a cam groove 64 of the lever 6 which will be described below. The temporary lock receiving portion 57 is defined at the peripheral edge of the first exposure opening 56A, wherein the temporary lock receiving portion 57 is configured to be locked to the lock arm 65 of the lever 6.

The temporary lock receiving portion 57 is arranged farther in the rear direction Y2 than a front end of the front mask 5 and formed to include a plane spanning along the right-left direction X and along the upward-downward direction Z.

The final lock receiving portion 58 is arranged at one end of the front mask 5 oriented in the right-left direction X and at a rear end of the front mask 5. The final lock receiving portion 58 is defined at a peripheral edge of a rectangular opening of the front mask 5 which allows the lock arm 65 of the lever 6 to be exposed, which will be described below.

The second exposure opening 56B is arranged on the other end side along the right-left direction X (on a side opposite to the final lock receiving portion 58 with respect to the first exposure opening 56A) and formed by cutting out part of the upper wall 51 and front wall 53 so that the second exposure opening 56B extends in the rearward direction X2 to expose a lock structure 66 of the lever 6 which will be described below.

The lever 6 is made of an insulating resin. As shown in FIG. 1, the lever 6 includes a first arm plate 61A (one of a pair of arm plates), a second arm plate 61B (the other of a pair of arm plates), and a connecting portion 62 connecting the first arm plate 61A to the second arm plate 61B, wherein the first arm plate 61A and the second arm plate 61B are opposed to each other and the inner housing 3 is interposed therebetween. In this manner, the lever 6 is formed in the form of a gate (C-shape).

The first arm plate 61A extends along the XY-plane (i.e., in the same direction as the upper surface 3A of the inner housing 3 and the upper wall 51 of the front mask 5) and thus has a plate shape.

The first arm plate 61A includes the bearing 63A, the cam groove 64, the lock arm 65 configured to be locked to the front mask 5, and the lock structure 66, wherein the bearing 63A is configured to be mated with the rotation shaft 31 of the inner housing 3 and the cam groove 64 is configured for inserting a guide protrusion of the partner connector 11 therethrough. The lock structure 66 is configured to be engaged with the engagement protrusion 133 of the partner connector 11.

The first bearing 63A is formed in a through-hole shape and configured for inserting the rotation shaft 31 of the inner housing 3 therethrough. In this manner, the lever 6 is pivotably mounted to be rotatable relative to the inner housing 3 around the rotation shaft 31 and the bearing 63A (63B). It is to be noted that the bearing 63A may not be formed in a through-hole shape, but in a recess shape in an inner surface of the first arm plate 61A. Furthermore, the bearing 63A of the first arm plate 61A may be formed in a protrusion shape, wherein the rotation shaft 31 of the inner housing 3 may be formed in a through-hole shape or a recess shape.

The cam groove 64 is formed in the form of a slit in the first arm plate 61A, wherein the slit has a cross-section with a recess shape. The cam groove 64 has a shape (trajectory) which allows the guide protrusion of the partner connector to be inserted therethrough, wherein the shape (trajectory) of the cam groove 64 is further configured to move the guide protrusion toward the first bearing 63A when rotating the lever 6.

As shown in FIGS. 1 and 2, the lock arm 65 is provided at an end of the first arm plate 61A facing away from the connecting portion 62. The lock arm 65 includes a cantilevered arm 65A and a lock protrusion 65B, wherein the arm 65A is bendable in the upward-downward direction Z, and the lock protrusion 65B protrudes in the upward direction Z1 from a free end of the arm 65A (in a direction pointing away from the second arm plate 61B).

As shown in FIG. 1, the arm 65A is formed by forming the slit S in the first arm plate 61A. The slit S is formed by cutting out part of an end edge of the first arm plate 61A facing away from the connecting portion 62. The slit S further extends rectilinearly toward the connecting portion 62.

As shown in FIGS. 2 and 3, the lock structure 66 is provided at an end of the first arm plate 61A which is closer to the connecting portion 62, wherein the lock structure 66 is configured to be engaged with the engagement protrusion 133 of the partner connector 11 when the lever 6 is in the completely rotated position 6B, whereby a mated state of the connector main body 10 with the partner connector 11 is maintained, as shown in FIG. 6.

As shown in FIG. 2, the lock structure 66 includes a lever arm 66B and the lock protrusion 66C provided at the lever arm 66B, the lever arm 66B being provided between a pair of slit portions 66A, 66A in the first arm plate 61A, wherein the lock protrusion 66C is engageable with the engagement protrusion 133 of the partner connector 11. In the completely rotated position 6B of the lever 6, the pair of slit portions 66A, 66A is formed by cutting out part of the first arm plate 61A at its rear end so that the slit portions 66A, 66A extend in the forward direction Y1. The lock protrusion 66C is provided between the pair of slit portions 66A, 66A and extends in the middle along the forward-rearward direction Y to protrude in the upward direction Z1.

As shown in FIG. 1, the second arm plate 61B includes a second bearing 63B configured to be mated with the rotation shaft 31 of the inner housing 3.

As shown in FIGS. 3 and 5, the connecting portion 62 includes the contact surface 620 (opposed surface) and an operating section 621 and is formed in a plate shape, wherein in the completely rotated position 6B of the lever 6, the contact surface 620 is capable of coming into contact with the connector façade 13A of the partner connector 11, and the operating section 621 is provided in a position which is facing away from the contact surface 620. The plate shape of the connecting portion 62 has a longitudinal direction defined by a direction along which the first arm plate 61A and the second arm plate 61B are opposed to each other (upward-downward direction Z).

A root 62A of the first arm plate 61A (this may be hereinafter referred to as “one root”) is continuous with an end of the contact surface 620 on one side thereof, wherein a root 62B of the second arm plate 61B (this may be hereinafter referred to as “the other root”) is continuous with an end of the contact surface 620 on the other side thereof. Furthermore, the contact surface 620 extends in a direction away from a forward end to interpose the roots 62A and 62B of the pair of arm plates 61A and 61B.

Moreover, in the completely rotated position 6B of the lever 6, the contact surface 620 is oblique so that the root 62B of the second arm plate 61B is positioned farther away from the partner connector 11 than the root 62A of the first arm plate 61A. Even when an operator mating the connector main body 10 with the partner connector 11 presses a location F of the operating section 621 of the lever 6 which is closer to the root 62B of the second arm plate 61B as shown in FIG. 4, the above configuration may prevent the root 62B of the second arm plate 61B from coming into contact with the connector façade 13A of the partner connector 11 before engagement of the lock protrusion 66C of the lever 6 with the engagement protrusion 133 of the partner connector 11.

The cover 7 is made of an insulating resin. As shown e.g. in FIGS. 1 and 2, the cover 7 includes a cover main body 70 and the housing lock portion 71 provided on the cover main body 70, wherein the cover main body 70 includes the electric wire insertion opening 7a and an attachment opening 7b for attaching the cover 7 to the inner housing 3 and configured to cover a face of the inner housing 3 oriented in the rear direction Y2. The housing lock portion 71 is configured to be locked to the cover lock receiving portion 33 of the inner housing 3.

Next, a procedure for assembling the lever-operated connector 1 will be described.

First, the inner housing 3 is moved toward a region between the first arm plate 61A and the second arm plate 61B of the lever 6 to interpose the inner housing 3 between the first arm plate 61A and the second arm plate 61B. In this manner, the bearings 63A and 63B are pivotably mounted to the respective rotation shafts 31, wherein the lever 6 is pivotably mounted to the inner housing 3 in a rotatable manner. In this manner, an assembled inner housing 3 with the lever 6 is obtained.

Subsequently, the inner housing 3 with the lever 6 is moved toward the accommodation opening 55 of the front mask 5 and inserted into the accommodation opening 55. In this manner, the front opening 30f of each of the terminal accommodating chambers 30A in the inner housing 3 is now in communication with the corresponding one of the communication holes 530, wherein the mask lock receiving portions 34 of the inner housing 3 are locked to the respective housing lock portions 59 of the front mask 5. Furthermore, the lever 6 is positioned in the completely rotated position 6B in which the lock protrusion 65B is locked to the final lock receiving portion 58 of the front mask 5. In this manner, the inner housing 3 with the lever 6 is accommodated in the front mask 5.

Subsequently, the spacer 4 is positioned in a temporary locked position of the inner housing 3, wherein the female terminals 2 connected to the electric wires are inserted into the terminal accommodating chambers 30A of the inner housing 3 through the rear opening 30b in the forward direction Y1. In this manner, the female terminals 2 are locked to the terminal lances. Subsequently, the spacer 4 is displaced from the temporary locked position to a final locked position. In this manner, a double-lock effect of each of the female terminals 2 is provided by the terminal lances and the spacer 4 to limit removal of the female terminals 2 out of the respective terminal accommodating chambers 30A. During this process, the electric wires connected to the female terminals 2 are drawn out of the inner housing 3.

Subsequently, the attachment opening 7b of the cover 7 is moved toward the inner housing 3 with the lever 6, wherein the electric wires drawn out of the inner housing 3 are inserted through the electric wire insertion opening 7a of the cover 7. In this manner, the cover lock receiving portions 33 are locked by the respective housing lock portions 71. Thus, the cover 7 is assembled with the inner housing 3 with the lever 6. During this process, the electric wires drawn out of the inner housing 3 extend out in one direction along the right-left direction X.

Subsequently, the lever 6 is rotated from the completely rotated position 6B to the initial position 6A. The lock arm 65 of the lever 6 is unlocked from the final lock receiving portion 58 of the front mask 5 so that the lever 6 is now in a rotatable state. Further rotation of the lever 6 locks the lock arm 65 to the temporary lock receiving portion 57 of the front mask 5, as shown in FIG. 2. In this state, the lock arm 65 is maintained in the initial position 6A by locking the lock arm 65 to the temporary lock receiving portion 57, wherein rotation of the lever 6 is limited in the initial position 6A. In this manner, the lever 6 is positioned in the initial position 6A so that the lever-operated connector 1 is completely assembled.

Subsequently, when mating the connector main body 10 of the lever-operated connector 1 with the partner connector 11, the connector main body 10 is moved toward and inserted into the hood section 132 of the partner connector 11 while the lever 6 of the lever-operated connector 1 is in the initial position 6A. In this manner, the guide protrusion of the partner connector 11 is inserted through the cam groove 64 of the lever 6 and is positioned in the vicinity of the entrance opening of the cam groove 64.

Next, the operating section 621 of the lever 6 is pressed to rotate the lever 6. By further pressing (rotating) the lever 6, the lever-operated connector 1 is displaced from the initial position 6A. As the lever 6 is further pressed, the lock protrusion 66C of the lock structure 66 comes into contact with the engagement protrusion 133 of the partner connector 11 so that the lever arm 66B of the lock structure 66 is bent in the downward direction Z2 and the lock protrusion 66C is thus pressed down below the engagement protrusion 133 in the downward direction Z2. By further pressing the lever 6, the lock protrusion 66C crosses over the engagement protrusion 133. When the lock protrusion 66C crosses over the engagement protrusion 133, the lever arm 66B is elastically returned to its original shape. By the lock protrusion 66C being positioned on a forward Y1 side of the engagement protrusion 133, the lock protrusion 66C is engaged with the engagement protrusion 133 (shown in FIGS. 6A and 6B). Substantially at the same time, the guide protrusion is positioned at a deepest end inside the cam groove 64 and the lever 6 reaches the completely rotated position 6B in which the lock arm 65 is locked to the final lock receiving portion 58, whereby the connector main body 10 is mated with the partner connector 11. The mated state of the connector main body 10 with the partner connector 11 is maintained by the lock protrusion 66C being engaged with the engagement protrusion 133.

Here, when an operator mating the connector main body 10 with the partner connector 11 presses the operating section 621 of the lever 6 to rotate the lever 6, the operating section 621 6 will be pressed along the oblique contact surface 620 toward the connector façade 13A of the partner connector 11 since the contact surface 620 is oblique so that the root 62B of the second arm plate 61B is positioned farther away from the connector façade 13A of the partner connector 11 than the root 62A of the first arm plate 61A, even if the location F of the operating section 621 of the lever 6 is pressed which is closer to the root 62B of the second arm plate 61B, as shown in FIG. 4.

This enables the lock protrusion 66C of the lever 6 to be engaged with the engagement protrusion 133 of the partner connector 11 before the root 62B of the second arm plate 61B at the contact surface 620 interferes with the connector façade 13A of the partner connector 11. In other words, it is possible to prevent the root 62B of the second arm plate 61B from interfering with the connector façade 13A of the partner connector 11 before engagement of the lock protrusion 66C of the lever 6 with the engagement protrusion 133 of the partner connector 11.

In this manner, it is ensured that the lock protrusion 66C of the lever 6 is engaged with the engagement protrusion 133 of the partner connector 11 so that a mating ensured state is established in which the mated state of the connector main body 10 with the partner connector 11 is maintained. As described above, the contact surface 620 is oblique so that the root 62B of the second arm plate 61B is positioned farther away from the partner connector 11 than the root 62A of the first arm plate 61A, which enables the operation efficiency of the connector mating operation to be improved while enabling failures in mating the partner connector 11 to be suppressed.

Although the best configuration, method etc. for implementing the present invention are disclosed in the above description, the present invention is not limited thereto. Namely, while the present invention is particularly shown and described mainly with regard to the specific embodiments, the above mentioned embodiments may be modified in various manners in shape, material characteristics, amount or other detailed features by those skilled in the art without departing from the scope of the technical idea and purpose of the present invention. Therefore, the description with limited shapes, material characteristics etc. according to the above disclosure is not limiting the present invention, but merely illustrative for easier understanding the present invention so that the description using names of the elements without a part or all of the limitations to their shapes, material characteristics etc. is also included in the present invention.

### REFERENCE SIGNS LIST

20 Connector unit
1 Lever-operated connector
10 Connector main body
11 Partner connector
6 Lever
61A First arm plate (one of a pair of arm plates)
61B Second arm plate (the other of the pair of arm plates)
62 Connecting portion
66C Lock protrusion (lock section)
620 Contact surface (opposed surface)
62A Root of the first arm plate (one root)
62B Rood of the second arm plate (the other root)

What is claimed is:

1. A connector unit comprising:
a partner connector and a connector main body which are capable of being mated with each other; and
a lever pivotably mounted to the connector main body and configured to be rotated relative to the connector main body,
wherein the lever is capable of being rotated between an initial position and a completely rotated position,
wherein in the completely rotated position, the partner connector is moved toward the connector main body and mated therewith,
wherein the lever includes:
a pair of arm plates which are opposed to each other with the connector main body being interposed between the pair of arm plates; and
a connecting portion connecting the pair of arm plates to each other,
wherein a lock section is provided on one of the pair of arm plates, the lock section being configured to lock the partner connector in the completely rotated position,
wherein the connecting portion includes an opposed surface which is configured to be opposed to the partner connector and capable of coming into contact with the partner connector in the completely rotated position, and
wherein the opposed surface is oblique so that a root of another of the pair of arm plates is positioned farther away from the partner connector than a root of the one of the pair of arm plates.
